(19) United States
(12) Patent Application Publication
(10) Pub. No.: US 2020/0188996 A1
(43) Pub. Date: Jun. 18, 2020

(54) ADDITIVE DESIGN AND MANUFACTURING FOR ELECTRIC MACHINES

(71) Applicant: Alliance for Sustainable Energy, LLC, Golden, CO (US)

(72) Inventors: Latha SETHURAMAN, Boulder, CO (US); Jonathan Allen KELLER, Golden, CO (US)

(21) Appl. No.: 16/718,630

(22) Filed: Dec. 18, 2019

Related U.S. Application Data
(60) Provisional application No. 62/781,110, filed on Dec. 18, 2018.

(51) Int. Cl. B22F 3/00; B33Y 30/00; B33Y 50/02; B33Y 70/00; B33Y 80/00

(52) U.S. Cl. CPC B22F 3/008; B33Y 30/00; B33Y 50/02; B22F 2301/35; B33Y 80/00; B22F 2301/052; B33Y 70/00

(57) ABSTRACT

Methods and systems for designing, optimizing, and manufacturing electric machine components are described herein. In some embodiments, the components are designed and optimized using artificial intelligence and manufactured using additive manufacturing.

### CROSS-REFERENCE TO RELATED APPLICATIONS

This application claims the benefit of U.S. Provisional Patent Application No. 62/781,110 filed on Dec. 18, 2018, the contents of which are incorporated by reference in their entirety.

### CONTRACTUAL ORIGIN

This invention was made with government support under Contract No. DE-AC36-08G028308 awarded by the Department of Energy. The government has certain rights in this invention.

### BACKGROUND

Wind turbine components are exposed to complex and dynamic loading, vibration, large forces, system fatigue, and joint stresses, so the components must be designed in such a way as to be durable when exposed to these effects. Additionally, reducing the size and weight of the components in a cost-effective manner enables taller and larger wind turbines. This is especially true for offshore wind turbines.

The choice of drive train is an important factor, as the generator impacts mass, efficiency, operation, maintenance reliability, and overall cost of energy. Gearboxes have many mechanical load-bearing components that are prone to reliability issues.

As the wind industry is migrating towards larger turbines, there is a growing emphasis on high-power-dense, efficient, and reliable drivetrains. However, the most power-dense electric machines use expensive rare earth permanent magnets (PMs) that are under constant threat of supply and price uncertainties. Manufacturing large PM generators is particularly challenging in terms of negotiating structural mass and optimal pole count.

### SUMMARY

An aspect of the present disclosure is system comprising a processor configured to receive a selected feature of a component, design, using machine learning, the component with the selected feature optimized, resulting in an optimized design having a shape, and a printer head configured to deposit a layer of a first material in the shape of the optimized design resulting in an optimized component. In some embodiments, the optimized component includes embedded sensors. In some embodiments, the printer head is further configured to deposit a layer of a second material in a portion of the shape of the optimized design. In some embodiments, the component is a stator. In some embodiments, the component is a rotor. In some embodiments, the first material is a ferromagnetic material. In some embodiments, the second material is structural steel. In some embodiments, the second material is iron. In some embodiments, the second material is aluminum. In some embodiments, the second material is a dielectric material. In some embodiments, the second material is a thermally conductive material. In some embodiments, designing the component comprises minimizing the selected feature while keeping of the component capable of being operable. In some embodiments, the selected feature is mass. In some embodiments, designing the component comprises maximizing the selected feature while keeping of the component capable of being operable. In some embodiments, the selected feature is torque. In some embodiments, the selected feature is efficiency.

### BRIEF DESCRIPTION OF THE DRAWINGS

Exemplary embodiments are illustrated in referenced figures of the drawings. It is intended that the embodiments and figures disclosed herein are illustrative rather than limiting.

FIG. 1 illustrates a system for the design and manufacture of electric machines as described herein.

FIG. 2 illustrates a printer head for additive manufacturing utilized herein.

FIG. 3 illustrates a flow chart showing a method of design and manufacture of electric machines as described herein.

FIG. 4 illustrates an example of an input of an initial stator design as utilized in some embodiments herein.

FIG. 5 illustrates an example of an optimized stator design as generated by some embodiments herein.

FIG. 6 illustrates an example of an optimized stator design as generated by some embodiments herein.

### DETAILED DESCRIPTION OF SOME EMBODIMENTS

Disclosed herein are methods and systems of additive design and manufacturing of advanced topology high torque-density reduced rare-earth/rare-earth free permanent magnet (PM)-based electric machines. The techniques described herein may use a combination of artificial intelligence-based multi-physics topology optimization routines with additive materials and advanced manufacturing processes such as three-dimensional (3D) printing which may result in ultra-optimal lightweight support structures, shape-optimized core and magnets with controlled directional field strength and in-situ magnetization. The techniques may include the integration of magnets, ferromagnetic cores, laminates, structural steel, and windings into rotors and/or stators in a manner that eliminates the traditional multiple cumbersome fabrication processes for advanced topology electric motors and generators. The techniques may utilize by hybrid manufacturing, which integrates traditional and additive manufacturing for electric machines.

Conventional magnet manufacturing and assembly requires the PM materials to be magnetized using conventional magnetizer structures that supply a high-energy magnetic field to align the magnetic dipoles. The magnetized PMs must be moved, stored, and finally inserted against strong repulsion and attraction forces with themselves or the ferromagnetic parts of the machine. The present disclosure includes multilayer printing of shape-optimized core structures and in-situ magnetization. This addresses the most cost-intensive and labor-intensive challenges of magnet handling and assembly.

Electric machines utilizing reduced rare-earth or rare-earth free magnets have failed to demonstrate enough torque-density to compete with their fully rare-earth counterparts. This problem may be mitigated by adding more magnets and active magnetic material for flux concentration which results in heavier machines. Additive manufacturing for PM machines as described herein provides an advanced, scalable, and ultra-efficient electric machine with high power density and significantly less, or even no, rare-earth material. The present disclosure combines generative design techniques and additive manufacturing for the most optimal use of active and structural materials throughout the machine. The present disclosure includes PM-derived electric machines configured to use advanced optimization techniques and employ artificial intelligence algorithms. The disclosed electric machine may be designed by a rigorous multi-physics-driven design space exploration as described herein which includes unlimited design freedom provided by multi-material manufacturing. The present disclosure enables the simultaneous design of low-cost high-performance magnets, ferromagnetic cores, structural steels, and insulation.

The techniques of the present disclosure may provide a viable alternative to critical rare-earth materials. The focus on weight reduction may have profound impacts for large offshore, direct-drive wind turbine generators where the levelized cost of energy can be reduced by up to 20%. Lightweight, high-performance motors may boost electric propulsion and other industrial applications (pumps, fans, compressors, materials processing, and refrigeration systems) where high-power densities have been difficult to realize. The techniques of the present disclosure may have the greatest impact on complex, high torque-density machine topologies that have been limited by manufacturing constraints. The techniques of the present disclosure may result in components and/or machines with complex topologies, such as transverse-flux permanent-magnet machines (TFPM).

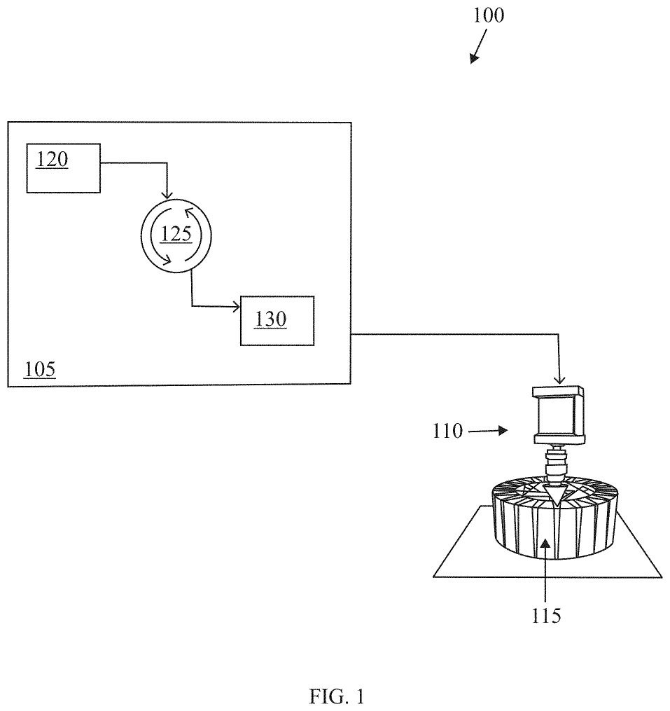

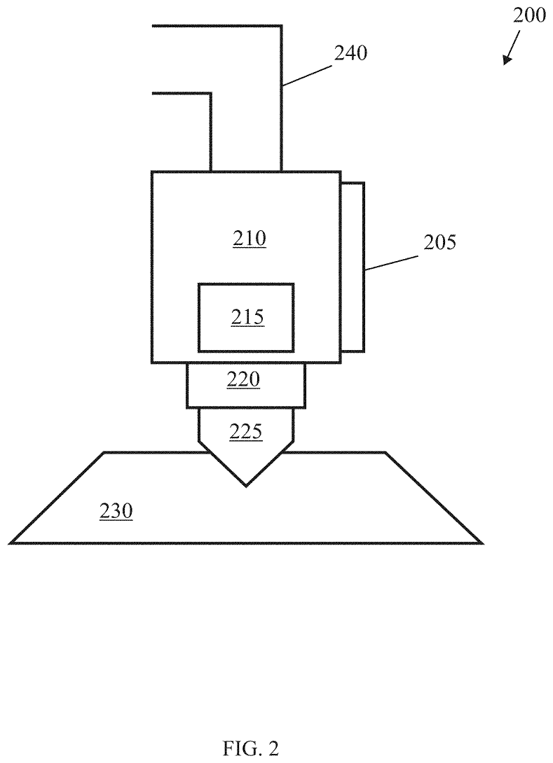

FIG. 1 illustrates a system for the design and manufacture of electric machines as described herein. The system 100 includes a processor 105, 3D printer 110, and a component 115. The component 115 is a component of an electric machine, for example, a rotor or stator. The 3D printer 110 is capable of multi-material manufacturing for an electric machine, or components of an electric machine. Additional details of one example of a 3D printer such as 3D printer 100 are described with respect to FIG. 2, below. The processor 105 is configured to receive an input component design 120, perform topology optimization 125, and result in a final, optimized component design 130. The 3D printer 110 is configured to perform multilayer printing of shape-optimized core and magnets with in-situ magnetization followed by layered deposition of structural steel. The system 100 may prevent the most cost-intensive and labor-intensive challenges of magnet handling and assembly as well as seamless integration of electromagnetic and structural parts of the electric machine. In some embodiments, the system 100 includes an ultra-dense shape-optimized magnet. Printed magnets may have higher energy density and flux focusing characteristics. The printer 110 may also be configured to deposit layers of copper conductors with insulation and shape optimized core material for a stator that overcomes the most labor-intensive challenges of winding electric machines.

The processor 105 is configured to use artificial intelligence (AI) algorithms, for example, machine learning, to optimize the shape and weight of electric machines by exploring many permutations of a component and/or machine design, generating hundreds of possible solutions based on design goals. Electric machines have many material and topology optimization opportunities. The present disclosure may be used to optimize electric machines and/or their components which are made with electromagnetic, thermal, and structural materials. In some embodiments, the techniques of the present disclosure integrate magnet fabrication with iron cores that remain dispersed for the two separate elements. In some embodiments, the present disclosure integrates winding of conductors into the additive manufacturing process.

FIG. 2 illustrates a printer head for additive manufacturing utilized herein. The 3D printer 200 includes a motor 205, a housing 210, a fan 215, a heating block 220, a nozzle 225, a print bed 230, and a connection 240. Collectively the motor 205, housing 210, heating block, 220, and nozzle 230 may be referred to as the extruder. The motor 205 converts electrical energy entering the 3D printer 200 via the connection 240 to mechanical motion, allowing the 3D printer 200 to move to create the optimized component and/or machine design generated by the processor (105 of FIG. 1). The housing 210 protects the 3D printer 200 and may include other multiple components, including a hobbed gear, a heat sink, and/or a thermistor (not shown). The housing 210 also allows operation of the 3D printer 200 to be performed safely by separating the components (which may be very hot) from users and external components. The fan 215 is directed at the component created by the 3D printer 200 and cools the material after it is deposited by the nozzle 225, helping the material to hold its shape. The heating block 220 contains a heater cartridge and thermocouple (not shown). The heating block 220 may be made of aluminum or another conductive material. The heating block 220 heats the powder as it flows through the 3D printer 200 and out through the nozzle 225. The nozzle 225 has a small hole (not shown) which releases the material onto the print bed 230. The print bed 230 is where the component is printed. It is made of a solid material, such as glass, concrete, or fiberglass. The print bed 230 may be heated to prevent the printed material from warping while it is exiting the nozzle 225 and being placed on the print bed 230. The connection 240 may provide connection to an electrical source and/or may contain metal alloys or material powders to be printed.

The techniques of the present disclosure combine design using advanced AI-based optimization routines with additive manufacturing to realize optimal distribution of electromagnetic, thermal, and structural materials. The methods described herein may result in electric machines with high torque density despite using magnets that are less powerful than rare-earth magnets or magnets made from new and high-performance materials or superconductors.

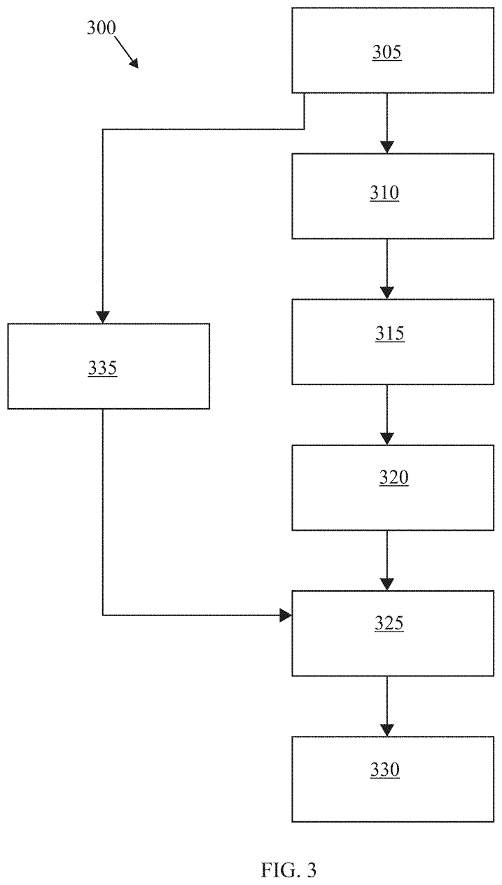

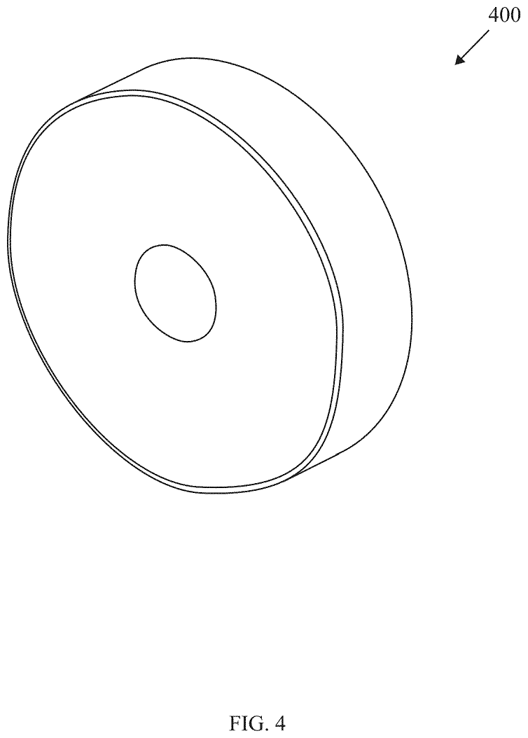

FIG. 3 illustrates a flow chart showing a method of design and manufacture of electric machines as described herein. The method 300 begins with the input of an initial design and at least one feature of the design to optimize 305. The design may be of a single component of an electric machine or of an entire electric machine. The design may be of a traditional design or may be a new design. The input design may be in computer aided design (CAD) format with representations of the physical parts being simulated as well as information regarding the material properties and applied loads and constraints. Features that may be inputted for optimization include mass (or weight) of a component or the entire machine, the amount of rare-earth magnetic material in a component, the torque of a component, or the efficiency of the entire machine. An example of an input of an initial design of a component is shown in FIG. 4. The baseline disc 400, shown in FIG. 4 is a stator disk, which may be used if the component is a stator. Other components or entire machines may be used as inputs for initial designs, based on the features to be optimized.

As shown in FIG. 3, in some embodiments, the method 300 includes performing a finite element analysis (FEA) 310 on the input to optimize the selected feature(s), resulting in converged solutions (i.e., optimized designs). This may be done by starting with a coarse mesh (meaning it has large elements) then refine the mesh. This means resolving the model with successively finer and finer meshes and comparing the results between these different meshes. Comparing means analyzing the fields at one or more points in the model or evaluating the integral of a field over some domains or boundaries. The design is expected to be converged when at least three respective solutions show a small value of change. The small value of change may be defined prior to performing FEA 310.

As shown in FIG. 3, in some embodiments, the method 300 includes performing an initial topology optimization 315 of the FEA mesh created in 310. The FEA mesh converges when at least three respective solutions show a small value of change. The converged solution(s) may be considered designs with the selected feature(s) optimized.

As shown in FIG. 3, in some embodiments, the method 300 includes using the converged solutions as training data and determining the suitability of the optimized designs 320. The optimized designs are used to “train” models to evaluate the performance of the components and/or machine(s). The performance is evaluated by determining whether the respective design is compliant with the needs of the component and/or machine and able to be printed using additive manufacturing. To simplify this analysis the optimized designs may be filtered and sorted for similarity. By using the optimized designs as training data, machine learning may be performed, which allows a processor to develop algorithms to quickly design and optimize future components.

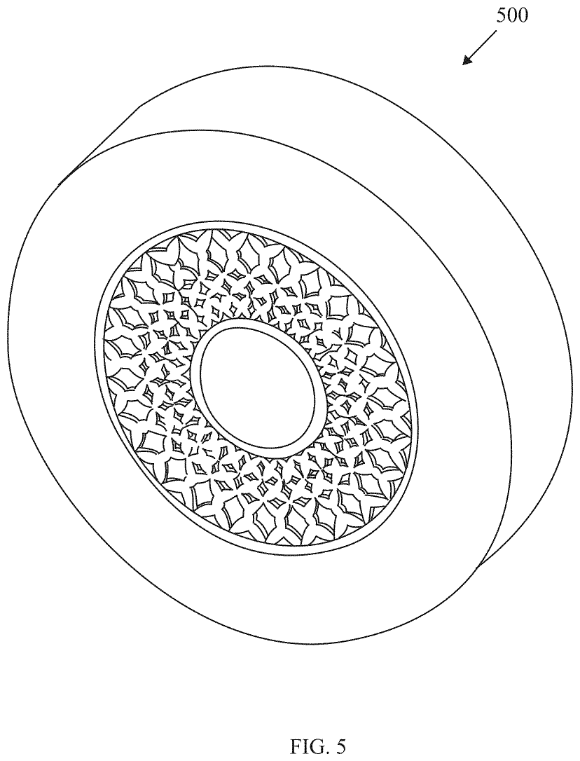

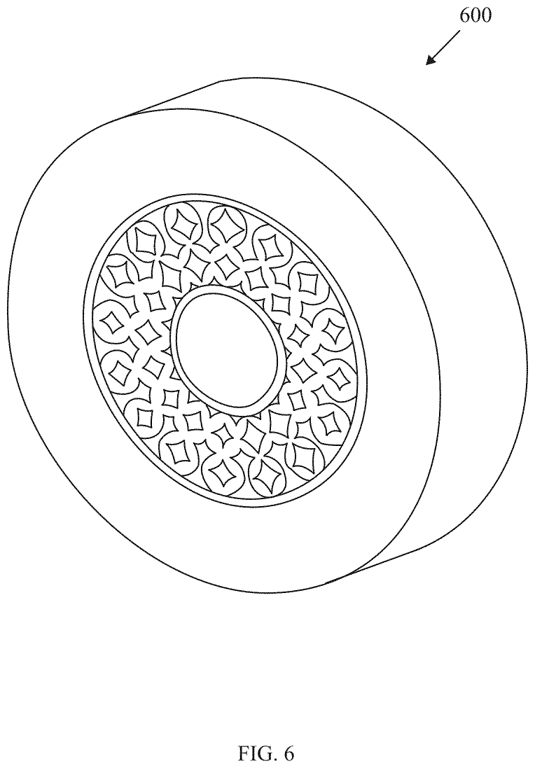

As shown in FIG. 3, in some embodiments, the method 300 includes generating a final optimized design 325. The final optimized design is generated based on the inputs and analysis performed in operations 305, 310, 315, and 320. An example of a final optimized design is shown in FIG. 5. The optimized stator disk 500, shows a generated optimized design for a stator (such as baseline disc 400 in FIG. 4) in which the mass of the stator disc was the selected feature to be optimized. The optimized stator disc 500 has less mass than the baseline disc 400, without showing significant deflection. A second example of a final optimized design is shown in FIG. 6. The optimized stator disc 600 also had the mass of the stator disc optimized. Both optimized stator discs 500 and 600 utilized the method 300 with a selected feature of mass to optimize. The optimized stator discs 500 and 600 both are suitable for use as a stator disc in a generator or other electric machine. The optimized stator discs 500 and 600 are examples only and not intended to be limiting as to how a component could be optimized using method 300.

As shown in FIG. 3, in some embodiments, the method 300 includes creating a component and/or multiple components based on the final optimized design 330. Creating the component based on the final optimized design may be done using a 3D printer (such as the 3D printer 200 shown in FIG. 2) which may create layers of material(s) to create the final optimized design. The components may be part of a generator (such as a stator, rotor, etc.) or may be parts of a heat exchanger or other machine. While the techniques of the present disclosure are presented with respect to wind turbines, the techniques could be applied to a range of industries and applications.

As shown in FIG. 3, in some embodiments the method 300 includes a topology optimization 335 of the input initial component design using the machine learning algorithms developed by 310, 315, and 320. This may be done after the algorithm has been “trained” using the optimized designs generated by 310, 315, and 320. After the topology optimization, the final design may be generated 325.

In the method 300 shown in FIG. 3, steps 310, 315, and 320 are performed for the algorithm to “learn” how to optimize components and the machine, so that a multi-variate indirect topology optimization 335 may be performed without performing a FEA (as in 310) each time a final optimized component or machine is desired.

The disclosed models may be used to create rotor designs and generate a rotor design using significantly less rare-earth material than traditional rotors. Printing the magnets using a 3D printer (such as the 3D printer 200 in FIG. 2) eliminates concerns about strong magnetic forces and handling the PMs during the manufacturing process. Using the methods described herein, designs are optimized to minimize losses from eddy currents in the poles and cores. The materials used for rotors and stators generated in methods herein may be steel, aluminum, or other solid materials.

The techniques of the present disclosure use multi-material additive processes to create the designed components. Using the methods described herein, components and machines may include high remanence, high resistance soft magnetic cores and reduced rare-earth/rare-earth free PM magnets, which are printed by a 3D printer (as 200 in FIG. 2). The methods described herein include fabricating ferromagnetic core laminations via additive manufacturing while depositing thin layers of insulation to help minimize eddy current losses, thus increasing the stacking factor of the individual component. This may eliminate traditional stamping of laminations and coating processes with insulating material. Hard magnets with unique 3D structures may be fabricated using additive manufacturing from mixed metal oxide powder precursors through a simple free-forming technique. In some embodiments, the methods described herein include the in-situ magnetization of 3D printed magnets, and the use of additive processes for structural parts with a ferromagnetic core, allowing unified integration of active parts in the proper orientation, topology, or configuration with inactive thermal and structural parts.

The techniques described herein are potentially transferable to other intricate components of drivetrains, such as internal channels in the pitch system and gearbox. The techniques of the present disclosure combine nuances of additive manufacturing and generative design for PM electric machines and electric machines with advanced magnets with no or reduced rare-earth materials, which can be used for wind turbine components and other electric machines. The magnets may be high-performance, low-cost magnets.

An air gap of a few millimeters between the rotor and stator demands tight tolerances, which is a serious production challenge when machining components up to six meters in diameter. Maintaining small air gaps requires structures to be extremely rigid and excessively massive. The problem is exacerbated when the designs become more complex to attain the high torque densities. Some embodiments of the present disclosure may create rotor and/or stator designs capable of achieving the necessary tolerances while optimizing other features, such as weight. The methods described herein allow for the component and/or machine to be designed and manufactured with precise tolerances, as well as evaluated for suitability and practicality of use. In some embodiments, the techniques of the present disclosure generate a configuration of sandwiched magnets between rotor poles resulting in double the torque density of the components and/or machines.

The techniques of the present disclosure utilize artificial intelligence algorithms to optimize shape and weight of components and/or machines through exploring many permutations of a design and generating hundreds of possible solutions based on design goals. These solutions are then evaluated, and the most-suitable designs are additively manufactured. Electric machines are an application with ample opportunities for material and topology optimizations, including electromagnetic and structural materials where generative design can have a great impact. The techniques described herein can transform generator or motor designs by co-creating with a computer to create optimized designs. In some embodiments, the techniques of the present disclosure can combine generative design and additive manufacturing to realize an advanced electric generator or motor of unconstrained optimality. The techniques of the present disclosure may overcome the mass, size, and cost challenges with rare-earth uncertainties.

In some embodiments, the techniques of the present disclosure create 3D printable designs of high torque dense reduced or rare-earth-free, PM-based electric generators, multi-material additive printing processes for rotors and stators integrating high- performance PMs that are rare-earth-free, soft magnetic cores, structural parts, stator winding, and insulation and heat exchanger using multi-material additive manufacturing processes.

References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. In some embodiments of the present disclosure, the term “substantially” is defined as approaching a specific numeric value or target to within 20%, 15%, 10%, 5%, or within 1% of the value or target. In further embodiments of the present disclosure, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present disclosure, the term “about” is used to indicate an uncertainty limit of less than or equal to ±20%, ±15%, ±10%, ±5%, or ±1% of a specific numeric value or target. In some embodiments of the present disclosure, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

In one or more examples, the techniques described herein may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media, which includes any medium that facilitates transfer of a computer program from one place to another, e.g., according to a communication protocol. In this manner, computer-readable media may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

The foregoing disclosure includes various examples set forth merely as illustration. The disclosed examples are not intended to be limiting. Modifications incorporating the spirit and substance of the described examples may occur to persons skilled in the art. These and other examples are within the scope of this disclosure and the following claims.

What is claimed is:

1. A system comprising:
a processor configured to:
receive a selected feature of a component,
design, using machine learning, the component with the selected feature optimized, resulting in an optimized design having a shape, and
a printer head configured to:
deposit a layer of a first material in the shape of the optimized design resulting in an optimized component.

2. The system of claim 1, wherein the optimized component includes embedded sensors.

3. The system of claim 1, wherein the printer head is further configured to:
deposit a layer of a second material in a portion of the shape of the optimized design.

4. The system of claim 3, wherein the component is a stator.

5. The system of claim 3, wherein the component is a rotor.

6. The system of claim 1, wherein the first material is a ferromagnetic material.

7. The system of claim 3, wherein the second material is structural steel.

8. The system of claim 3, wherein the second material is iron.

9. The system of claim 3, wherein the second material is aluminum.

10. The system of claim 3, wherein the second material is a dielectric material.

11. The system of claim 3, wherein the second material is a thermally conductive material.

12. The system of claim 1, wherein designing the component comprises minimizing the selected feature while keeping of the component capable of being operable.

13. The system of claim 12, wherein the selected feature is mass.

14. The system of claim 1, wherein designing the component comprises maximizing the selected feature while keeping of the component capable of being operable.

15. The system of claim 14, wherein the selected feature is torque.

16. The system of claim 14, wherein the selected feature is efficiency.
